(19) United States
(12) Patent Application Publication
(10) Pub. No.: US 2018/0128117 A1
(43) Pub. Date: May 10, 2018

(54) SELF-SEALING IMPINGEMENT COOLING TUBE FOR A TURBINE VANE

(71) Applicant: ROLLS-ROYCE plc, London (GB)

(72) Inventors: Anthony J. RAWLINSON, Derby (GB); Salwan SADDAWI, Derby (GB)

(73) Assignee: ROLLS-ROYCE plc, London (GB)

(21) Appl. No.: 15/786,815

(22) Filed: Oct. 18, 2017

(30) Foreign Application Priority Data
Nov. 7, 2016 (GB) 1618710.6

(51) Int. Cl. F01D 5/18

(52) U.S. Cl. CPC F01D 5/189; F05D 2240/121; F05D 2260/201; F05D 2240/303; F05D 2240/304; F05D 2240/122

(57) ABSTRACT

A self-sealing impingement cooling tube comprises a perimeter wall (51) defining a first end (54) and a second end (53), for example these may be a trailing edge and leading edge ends of an aerofoil. First and second wall sections extend from the first end (54) to the second end, the first and second wall sections joining at the first end. An adjustable gap (53) resides between the wall sections at the second end. One or both of the first and second wall sections is resiliently deformable such that the first and second wall sections can be positioned closer together and the adjustable gap (53) simultaneously reduced whereby to enable the tube to be inserted into a cavity which has a dimension smaller than the distance between the first and second wall sections when the perimeter wall (51) is not under load.

### CROSS-REFERENCE TO RELATED APPLICATION

This application is based upon and claims the benefit of priority from British Patent Application Number 1618710.6 filed 7 Nov. 2016, the entire contents of which are incorporated by reference.

### FIELD OF DISCLOSURE

The present disclosure relates to the cooling of vanes in the turbine section of a gas turbine engine. More particularly the disclosure is concerned with an impingement cooling tube configured for insertion into such a vane.

### BACKGROUND

An example of a known gas turbine engine is shown in FIG. 1 in a sectional side view. With reference to FIG. 1, a gas turbine engine is generally indicated at 10, having a principal and rotational axis 11. The engine 10 comprises, in axial flow series, an air intake 12, a propulsive fan 13, a high-pressure compressor 14, combustion equipment 15, a high-pressure turbine 16, a low-pressure turbine 17 and an exhaust nozzle 18. A nacelle 20 generally surrounds the engine 10 and defines the intake 12.

The gas turbine engine 10 works in the conventional manner so that air entering the intake 12 is accelerated by the fan 13 to produce two air flows: a first air flow into the high-pressure compressor 14 and a second air flow which passes through a bypass duct 21 to provide propulsive thrust. The high-pressure compressor 14 compresses the air flow directed into it before delivering that air to the combustion equipment 15.

In the combustion equipment 15 the air flow is mixed with fuel and the mixture combusted. The resultant hot combustion products then expand through, and thereby drive the high and low-pressure turbines 16, 17 before being exhausted through the nozzle 18 to provide additional propulsive thrust. The high 16 and low 17 pressure turbines drive respectively the high pressure compressor 14 and the fan 13, each by suitable interconnecting shaft.

In attempts to ever improve engine efficiency, turbine components are subjected to increasingly high temperatures. Materials used in the manufacture of such components may be subject to phase change at excessive temperatures; these changes can result in distortion and consequent damage within the turbine. Engine efficiency and component life can be compromised if the temperature of critical components is not maintained within an acceptable range. It is well known to cool turbine components during engine operation. Typically this involves delivering air from the compressor which has by-passed the combustor and so, relative to the working fluid in the turbine annulus, is cool.

It is desirable to minimise weight in a gas turbine engine, particularly when used to propel an aircraft. This is in part achieved through the use of hollow components. The presence of cavities in the components presents an opportunity to cool the components from within by passing cooling air through these cavities. It is known to improve cooling efficiency by impingement cooling. This typically involves providing an impingement cooling tube within a cavity, the tube having perforated walls. Cooling air is delivered into the tube and is then directed at internal walls of the cavity in small jets through the perforations providing effective cooling of the wall surface bounding the cavity.

One example where such impingement cooling tubes are known to be used is in hollow vanes of a stator in a turbine stage. The impingement cooling tube is typically welded into the vane. Since the impingement tube is not a structural component, it can be made from less high grade and costly materials than those used for the vane itself. Different properties in the materials can present difficulties in welding and different thermal properties can result in some separation and leakage of cooling air between the components.

It is desirable to mitigate some of the shortcomings described in relation to prior known designs.

### BRIEF SUMMARY

In accordance with the present disclosure there is provided an impingement cooling tube comprising a perimeter wall defining a first end and a second end, and first and second wall sections extending from the first end to the second end, the first and second wall sections joining at the first end and an adjustable gap between the wall sections at the second end; one or both of the first and second wall sections being resiliently deformable such that the first and second wall sections can be positioned closer together and the adjustable gap simultaneously reduced whereby to enable the tube to be inserted into a cavity which has a dimension smaller than the distance between the first and second wall sections when the perimeter wall is not under load.

The perimeter wall may contain an array of infringement cooling holes. The impingement cooling tube may be substantially aerofoil-shaped in cross section, for example, to complement the shape of an internal wall of a cavity in a turbine vane of a gas turbine engine. The first end may be the trailing edge of the aerofoil, the second end being the leading edge.

In some embodiments, one or both of the first and second wall sections include an inwardly directed bend or curve adjacent the first end.

Some embodiments of impingement cooling tubes in accordance with the disclosure may be located in a cavity bounded by a wall, the wall of the cavity being adapted to retain the tube. In one example, ends of the perimeter wall at the second end of the tube may be inwardly curved or angled for engagement in a suitably configured catch provided on the wall of the cavity. Such a catch may comprise elongate grooves extending from a top to a bottom of the tube.

A lip may be provided at one or both ends of an adapted cavity wall. In another example, one or more protrusions may be provided on a wall of the cavity and a complementing hole provided on the perimeter wall. For example, a protrusion is provided where the first end of the impingement tube abuts the wall of the cavity.

The impingement tube need not comprise the same material as the wall of the cavity.

It will be appreciated that any of the retaining features mentioned above may be used individually or in combination with one or more of the others whereby to improve the retention and sealing of the impingement tube when inserted in the cavity.

### BRIEF DESCRIPTION OF DRAWINGS

Some embodiments of the invention will now be further described with reference to the accompanying Figures in which;

FIG. 1 shows a sectional side view of a known gas turbine engine into which impingement cooling tubes in accordance with the invention may usefully be employed;

FIG. 2 shows a view of a turbine vane as known in the prior art;

FIG. 3 shows an impingement cooling tube as known from the prior art;

FIG. 4 shows the impingement cooling tube of FIG. 3 located in a cavity of turbine vane in a manner known in the prior art;

FIG. 5 shows a cross section of an impingement cooling tube in accordance with a first embodiment of the invention;

FIG. 6 shows a cross section view of an impingement cooling tube in accordance with a second embodiment of the invention and related features of a turbine vane into which the infringement cooling tube is configured to be received;

FIG. 7 shows relevant components of FIG. 6 in greater detail;

FIG. 8 shows a cross section of an impingement cooling tube in accordance with a third embodiment of the invention;

FIG. 9 shows a cross section of an infringement cooling tube in accordance with a fourth embodiment of the invention;

FIG. 10 shows features of a turbine vane and impingement cooling tube combination in accordance with an embodiment of the invention;

FIG. 11 shows features of a turbine vane and impingement cooling tube combination in accordance with an alternative embodiment of the invention;

FIG. 12 shows a cross section view of an impingement cooling tube in accordance with another embodiment of the invention and related features of a turbine vane into which the infringement cooling tube is configured to be received;

FIG. 13 shows relevant components of FIG. 12 in greater detail;

FIG. 14 shows relevant components of an alternative catch configuration for the embodiment of FIG. 12.

### DETAILED DESCRIPTION

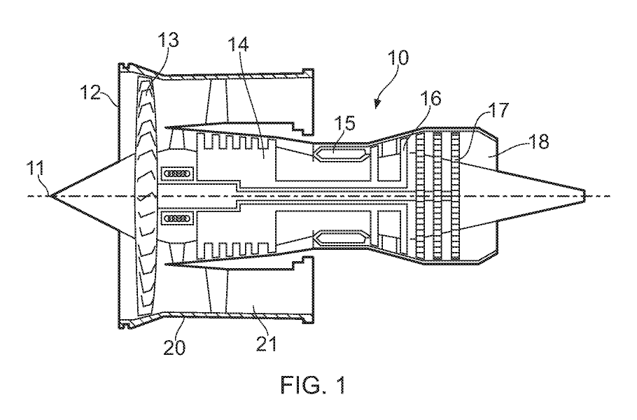

FIG. 1 has been described above.

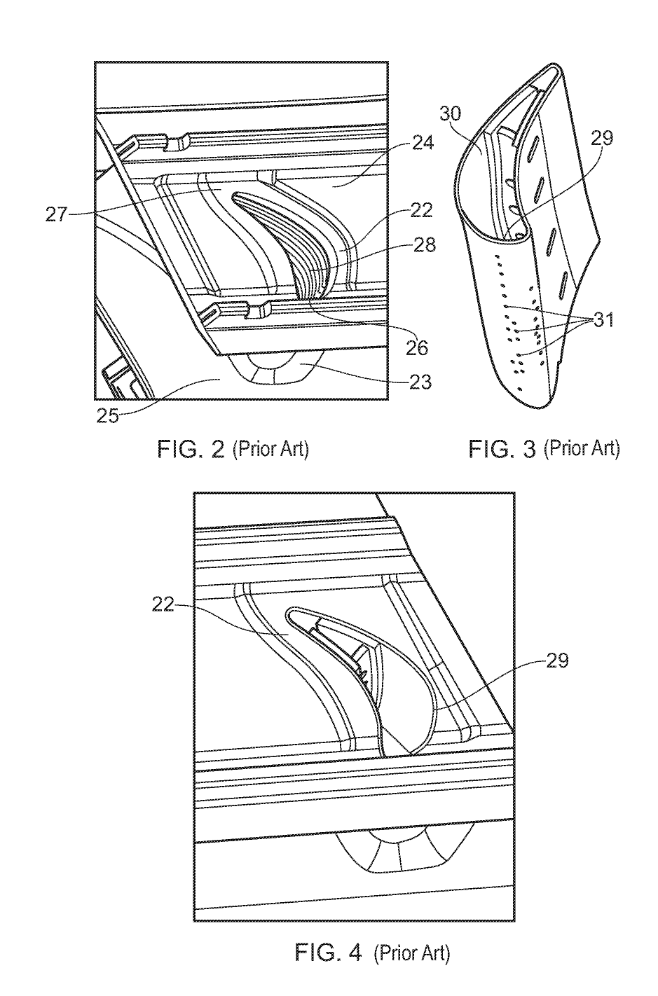

FIG. 2 shows a view of a vane arranged in a stator of a gas turbine engine. The vane comprises an elongate body 23 having an aerofoil shaped cross-section defined by a wall 22 forming a leading edge 26, a trailing edge 27 and a cavity 28. The wall 22 and cavity 28 extend between a radially outer annular platform 24 and a radially inner platform 25.

FIG. 3 shows an impingement cooling tube as known from the prior art. The tube comprises a wall 29 defining a cavity 30. The wall has perforations 31 arranged on its surface. The perforations 31 serve, in use, as impingement cooling holes. As can be seen, the tube has an aerofoil shaped cross-section and is proportioned to fit snugly within the cavity 28 as shown in FIG. 4. The tube is typically welded into position in the vane cavity 28.

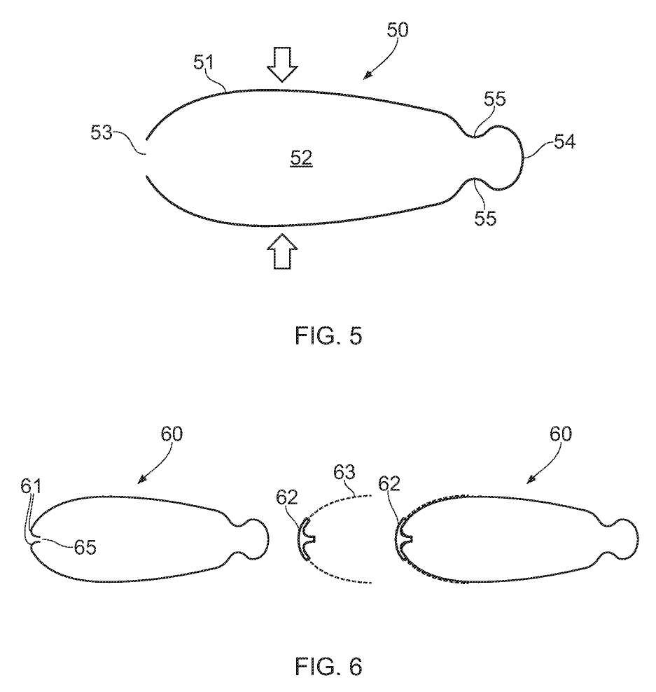

FIG. 5 shows an impingement tube 50 in accordance with a first embodiment of the invention. The tube has a broadly aerofoil-shaped cross section configured to fit within an aerofoil shaped cavity of a vane. The tube has a perimeter wall 51 bordering a cavity 52. At a leading edge of the tube there is a gap 53 in the perimeter wall 51. At a trailing edge, the perimeter wall 51 includes a bulbous section 54 which converges to define two oppositely facing concave sections 55. This shape combined with the material and wall thickness of the tube 50 enables the tube to be compressed when a load is applied in the direction of the arrows shown, closing the gap 53. The tube 50 is, however, resilient and removal of the load causes the tube to spring open, re-opening the gap 53.

The tube 51 is designed such that, in an unloaded condition, the spacing between oppositely facing sides of the perimeter wall 51 is greater than the spacing between oppositely facing sides of a wall of a cavity in a vane into which the tube is configured to be received. In use, load is applied to the oppositely facing sides of the perimeter wall reducing the spacing therebetween and allowing the tube to be inserted into the narrower vane cavity. Once inside the cavity, the load is released, forcing the perimeter wall 51 against an inner surface of the wall defining the vane cavity. The tube 51 is thus self-sealing.

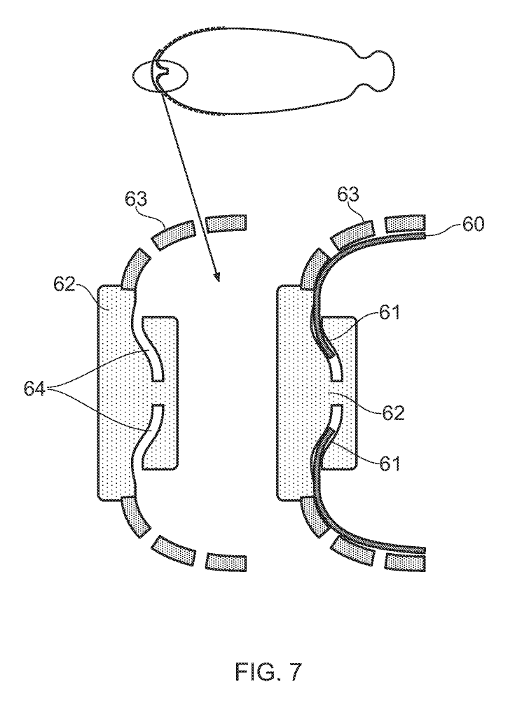

FIG. 6 shows a second embodiment of an impingement tube 60 in accordance with the invention. The tube is broadly similar to that shown in FIG. 5 but includes inwardly curling ends 61 of the perimeter wall adjacent the gap 65. The figure shows a representation of a wall 63 (in dotted outline) of a vane cavity. Arranged in the leading edge of the vane is a catch 62. The catch 62 is shown in more detail in FIG. 7. As can be seen, the catch 62 includes inwardly curling grooves 64 configured to receive the curling ends 61 of the impingement tube 60. This engagement between the curling ends 61 and curling grooves 64 along with the abutment of the tube perimeter wall against the wall 63 of the vane cavity locks the tube 60 into position in the vane cavity. The engagement between the curling ends 61 and curling grooves 64 also serves to seal the tube 60 at the leading edge.

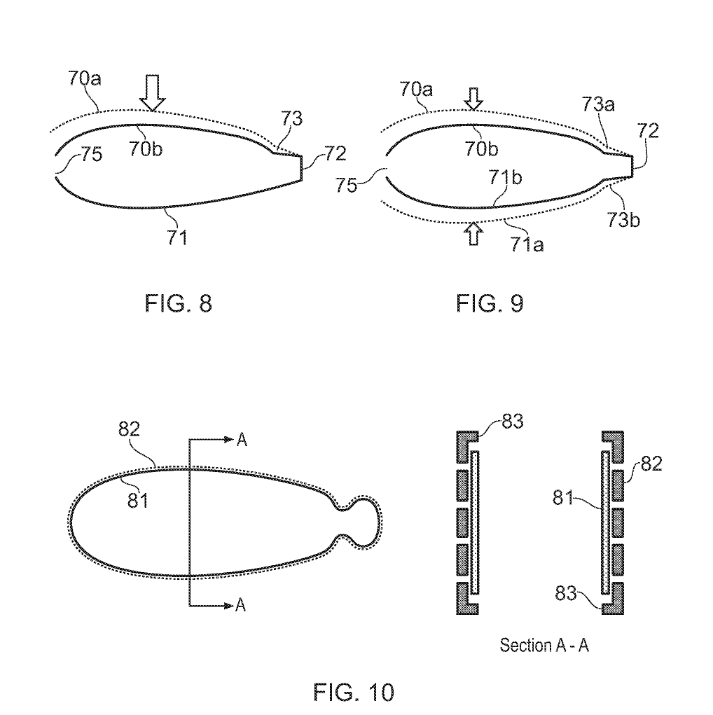

FIGS. 8 and 9 show two more alternative embodiments of impingement tubes constructed in accordance with the invention. The embodiments differ from those shown in FIGS. 5 to 7 by having a different shape at the trailing edge end. As can be seen in FIG. 8, the tube has a perimeter wall comprising a flat trailing edge end 72 from which extends two oppositely facing wall sections 70a/70b and 71. Reference numerals 70a and 70b illustrate two positions of the wall section. 70a (dotted outline) represents the perimeter wall when not under load; 70b (solid line) represents the perimeter wall when loaded in the direction of the arrow. As can be seen first wall section 71 curves smoothly from the trailing edge 72 to the leading edge 75. In contrast the wall section 70a/70b includes an inwardly directed bend 73 adjacent the trailing edge end 72. The configuration is such that, under load, the wall section moves from a first position 70a to a second position 70b which is closer to the wall portion 71.

The embodiment of FIG. 9 is substantially similar to that of FIG. 8; however, both wall portions include an inwardly directed bend 73a, 73b near the trailing edge end 72. When the perimeter wall is loaded as represented by the arrows, the oppositely facing wall portions move from first positions 70a, 71a (dotted outlines) to second positions 70b, 71b closing the gap at leading edge 75.

FIG. 10 shows an impingement cooling tube in accordance with an embodiment of the invention inserted in a modified vane 82. The impingement tube has a perimeter wall 81 and the vane has a cavity perimeter wall 82. As can be seen in the sectional view through A-A shown to the right of the Figure, a small inwardly directed lip 83 is provide at a top and bottom end of the perimeter wall 82. These lips 83 serve to seal and retain the tube at the top and bottom ends.

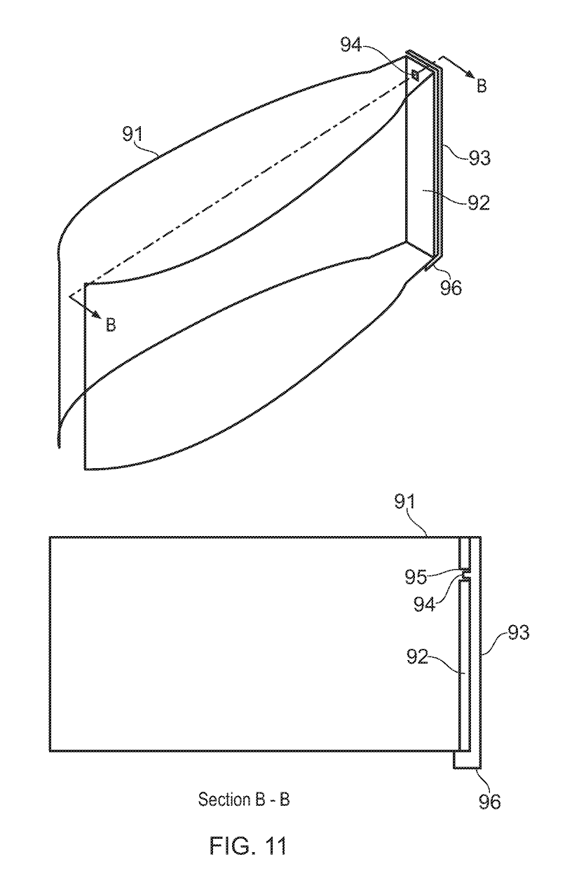

FIG. 11 shows another embodiment of an impingement cooling tube in accordance with the invention. The tube has a perimeter wall 91 including a flat trailing edge end 92 which abuts against a trailing edge wall section 93 of a vane cavity perimeter wall. A projection 94 extends inwardly from the trailing edge wall section 93 of the vane cavity perimeter wall and engages in a hole 95 in the flat trailing edge end 92. The trailing edge wall section 93 includes a lip 96 which assists in locating and retaining the tube in position within the vane cavity.

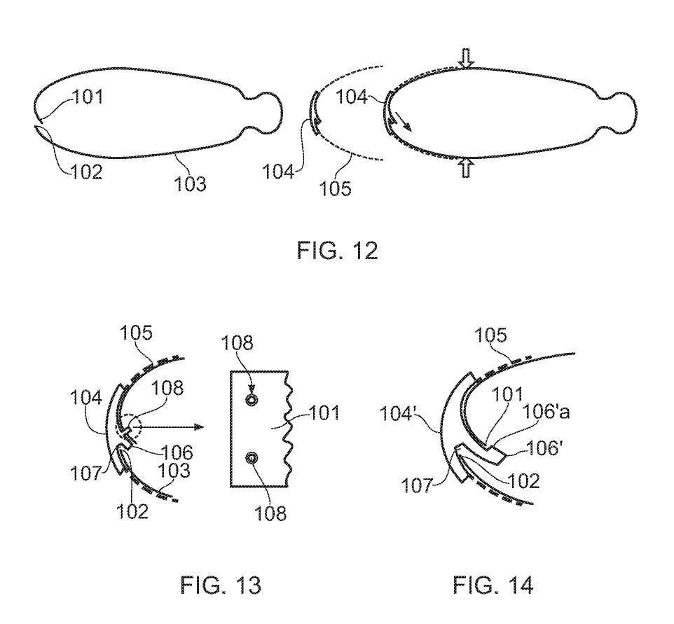

FIG. 12 shows another embodiment of an impingement tube in accordance with an embodiment of the invention. The tube is broadly similar to that shown in FIG. 5 but includes first and second ends 101, 102 of the perimeter wall 103 which are misaligned. When a load is applied to opposing outer walls, the ends 101, 102 move to overlap each other (as illustrated by the arrows shown in the right hand side image). The ends 101, 102 can be captured in a suitably configured catch 104 formed on an inwardly facing surface of a vane cavity wall 105. FIGS. 13 and 14 illustrate two alternative catch configurations suited to use with the tube of FIG. 12.

FIG. 13 shows a first configuration of a suitable catch 104. The catch includes an inwardly extending arm 106 which, in use, locates between the ends 101, 102 of the perimeter wall 103 of a cooling tube. On one side, the arm 106 defines with the wall 105 a groove 107 into which an outwardly facing end 102 is received. On an opposite side of the arm 106, a pair of pins 108 project substantially orthogonally from the arm 106. The pins locate in proportionately sized holes provided in an inwardly facing end 101 of the perimeter wall 103.

FIG. 14 shows a similar shaped catch 104′ having an arm 106′ which again bounds a groove 107 into which an outwardly facing end 102 of the perimeter wall 103 is received. In contrast to the arrangement of FIG. 13, no pins are present but a step 106′a is fashioned adjacent a free end of the arm 106′. Inwardly facing end 102 of the tube wall 103 abuts against a surface of the step 106′a.

Gas turbine engines to which impingement tubes of the present invention may be applied may have configurations different to that described above. By way of example such engines may have an alternative number of interconnecting shafts (e.g. three) and/or an alternative number of compressors and/or turbines. Further the engine may comprise a gearbox provided in the drive train from a turbine to a compressor and/or fan.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

1. An impingement cooling tube comprising a perimeter wall defining a first end and a second end, and first and second wall sections extending from the first end to the second end, the first and second wall sections joining at the first end and an adjustable gap between the wall sections at the second end; one or both of the first and second wall sections being resiliently deformable such that the first and second wall sections can be positioned closer together and the adjustable gap simultaneously reduced whereby to enable the tube to be inserted into a cavity which has a dimension smaller than the distance between the first and second wall sections when the perimeter wall is not under load.

2. An impingement cooling tube as claimed in claim 1 wherein the perimeter wall contains an array of impingement cooling holes.

3. An impingement cooling tube as claimed in claim 1 wherein the impingement cooling tube is substantially aerofoil-shaped in cross section.

4. An impingement cooling tube as claimed in claim 3 wherein the first end is the trailing edge of the aerofoil, the second end being the leading edge.

5. An impingement cooling tube as claimed in claim 1 wherein one or both of the first and second wall sections includes an inwardly directed bend or curve adjacent the first end.

6. A combination of an impingement cooling tube as claimed in claim 1 with a component having a cavity into which the impingement cooling tube is received, ends of the perimeter wall at the second end being inwardly curved or angled for engagement in a suitably configured catch provided on a wall of the cavity.

7. A combination as claimed in claim 6 wherein the catch comprises elongate grooves extending from a top to a bottom of the catch.

8. A combination as claimed in claim 6 wherein an inwardly directed lip is provided at one or both of a top and bottom end of the cavity wall.

9. A combination as claimed in claim 6 wherein one or more protrusions is provided on a wall of the cavity and a complementing hole provided on the perimeter wall of the tube.

10. A combination as claimed in claim 9 wherein the hole and protrusion are provided at the first end of the tube.

11. A combination as claimed in claim 6 wherein the component is a vane for a stator of a turbine stage.

12. A combination as claimed in claim 6 wherein the catch has an arm which projects into the cavity defining on one side of the arm a groove for receiving a first end of the tube and on the other side a formation for restricting movement of a second end of the tube.

13. A combination as claimed in claim 12 wherein the formation comprises one or more pins on the arm configured to engage in holes in the second end.

14. A combination as claimed in claim 12 wherein the formation comprises a step at a free end of the arm.

15. A stator for a turbine stage of a gas turbine engine, the stator comprising at least one vane into which is received an impingement cooling tube having the configuration as claimed in claim 1.

16. A stator for a turbine stage of a gas turbine engine, the stator comprising at least one vane into which is received an impingement cooling tube wherein the combination of the impingement cooling tube and the vane has a configuration substantially as defined in claim 6.

17. A gas turbine engine comprising at least one turbine stage, the turbine stage including a stator having the configuration as defined by claim 11.
